(19) United States
(12) Patent Application Publication
(10) Pub. No.: US 2014/0127593 A1
(43) Pub. Date: May 8, 2014

(54) METAL-AIR BATTERY SYSTEM WITH DETACHABLE ANODE AND CATHODE COMPARTMENTS

(71) Applicants: ZONGXUAN HONG, HOUSTON, TX (US); CUNXI SHEN, HOUSTON, TX (US); AIYING CHEN, XIAPU (CN)

(72) Inventors: ZONGXUAN HONG, HOUSTON, TX (US); CUNXI SHEN, HOUSTON, TX (US); AIYING CHEN, XIAPU (CN)

(21) Appl. No.: 13/669,005

(22) Filed: Nov. 5, 2012

(51) Int. Cl. H01M 12/06

(52) U.S. Cl. CPC H01M 12/06
USPC 429/402; 29/623.1

(57) ABSTRACT

The metal-air battery system of this invention has a detachable anode compartment and cathode compartment for producing electric current, wherein the anode compartment and the cathode compartment are pressed into contact when the battery is put in use to generate electric power; and the anode compartment and the cathode compartment are separated when the battery is not in use to generate electric power. The anode compartment also has an injection device to inject water mist to maintain the moisture level of the metal gel inside the anode compartment. The metal-air battery system of this invention will extend the battery storage life significantly as compared to conventional metal-air battery. In addition, the metal-air battery system of this invention makes replacing anode conveniently so that the battery system can be re-used continuously.

### FIELD OF THE INVENTION

This invention relates generally to a metal-air battery system with detachable anode compartment and cathode compartment, wherein the anode compartment and cathode compartment are pressed into contact when the battery system is put in use to generate electric power; and the anode compartment and cathode compartment are separated and sealed when the battery system is not in use to generate electric power.

### BACKGROUND OF THE INVENTION

Conventional metal-air battery, in particular, zinc air battery, consists a cathode and an anode, separated by a separator; and the cathode and anode are constructed in contact as a battery unit to provide electric power. In such metal-air battery, for example, zinc air battery, the cathode contains oxygen, an electrode catalyst capable of converting oxygen into hydroxyl anions, and a current carrier. The anode is a type of metal, for example, zinc, and it is mixed with electrolyte, usually, potassium hydroxide. In the conventional metal-air battery, the anode together with electrolyte, for example, zinc gel with potassium hydroxide, is built in direct contact with the cathode only be separated by a separator. The compartment for cathode has openings that allow oxygen from the air to enter the cathode. When the battery is in use to generate electric power, oxygen from the air enters through the openings and is reduced by the cathode catalyst to produce hydroxide ions. However, the activity of the cathode catalyst will decrease if the catalyst adsorbs excess amount of water. Therefore, in conventional zinc air battery, the container openings are sealed by an adhesive backed tab prior to use. This tab is removed before the battery is put into service to allow air entering the cathode compartment.

Nevertheless, the current zinc air battery, or any type of metal-air battery with current cell design and construction, still has the drawback from leakage of electrolyte from separator into cathode thereby saturating the cathode catalyst even with cathode opening sealed. This will degrade the battery. In addition, the electrolyte can leak through the cell seal resulting in loss of electrolyte, thereby losing battery power.

In this invention, we disclosed a novel metal-air battery design that can solve both of the above mentioned drawbacks from conventional metal-air battery, and can extend battery life tremendously, both before and after use.

### SUMMARY OF THE INVENTION

This invention discloses a metal-air battery system with detachable anode compartment and cathode compartment for producing electric current. The metal-air battery system comprises of a detachable anode compartment, a detachable cathode compartment, an electrolyte, and a separator. The anode compartment comprises of at least one type of metal gel together with the electrolyte, and the anode compartment has a metal screen at the bottom of the anode compartment to hold metal gel within the anode compartment. The cathode compartment comprises of oxygen, and/or air, an electrode catalyst, and a current carrier. The separator separates the anode with the cathode.

The anode compartment and cathode compartment are pressed into contact when the battery is put in use to generate electric power; and the anode compartment and the cathode compartment are separated when the battery is not in use to generate electric power, and the metal gel together with the electrolyte in the anode compartment is held by the metal screen at the bottom of anode compartment.

In a preferred embodiment of this invention, the metal-air battery is a zinc air battery, and the metal anode is zinc.

In another embodiment of this invention, the anode compartment contains another movable plate that can seal the opening of the metal screen when the battery is not in use, and can be removed when the battery is in use to allow direct contact of anode compartment with cathode compartment.

In another embodiment of this invention, a water mist injector is installed on the anode compartment in which a desired and controllable amount of water mist and/or electrolyte mist can be injected into metal gel.

In another embodiment of this invention, a mechanism of stirring is installed on the anode compartment in which stirring of metal gel can be initiated when desired. Such stirring involves mixing of metal gel with injected electrolyte and/or water, and movement of metal gel.

In another preferred embodiment of this invention, each metal-air battery cell can be connected in series and/or in parallel to generate desired amount of electric power.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of this invention.

FIG. 1 is a schematic drawing of a metal-air battery system having features of this invention. The battery system comprises of detachable anode compartment, detachable cathode compartment, and a separator, wherein said anode compartment contains metal gel together with electrolyte, and the metal gel is held by a metal screen at the bottom of the anode compartment, said cathode compartment contains oxygen, cathode catalyst, and current carrier. When the battery is put in use to generate electric power, the anode compartment and cathode compartment are pressed into contact, with the metal screen in direct contact with the separator and cathode catalyst. When the battery is not in use, the anode compartment and cathode compartment are separated, and the metal gel is held up by the metal screen in the anode compartment.

FIG. 2 is a schematic drawing of another embodiment of the battery system having features of this invention. The battery system comprises of detachable anode compartment, detachable cathode compartment, and a separator, wherein said anode compartment contains metal gel together with electrolyte, and the metal gel is held by a metal screen at the bottom of the anode compartment, said cathode compartment contains oxygen, cathode catalyst, and current carrier, and additionally, the anode compartment is equipped with an injection device for water and/or electrolyte addition to the metal gel when needed. When the metal gel loses moisture, a desirable amount of water and/or electrolyte is added through the injection port to the anode compartment.

FIG. 3 is a schematic drawing of another embodiment of the battery system having features of this invention. The battery system comprises of detachable anode compartment, detachable cathode compartment, and a separator, wherein said anode compartment contains metal gel together with electrolyte, and the metal gel is held by a metal screen at the bottom of the anode compartment, said cathode compartment contains oxygen, cathode catalyst, and current carrier, and additionally, the anode compartment is equipped with stirring device and such device can induce movement of metal gel when needed. When the battery power shows output power decrease, a stirring is initiated to a movement of the metal gel.

### DETAILED DESCRIPTION OF THE PREFERRED EMBODIMENTS

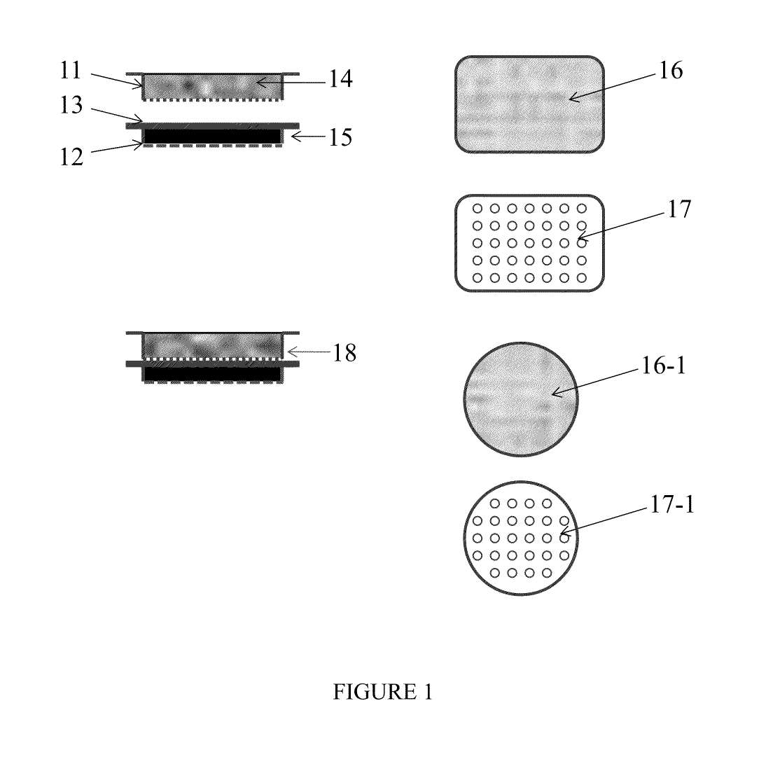

FIG. 1 is a schematic drawing of the battery system having the features of this invention, wherein the battery comprises of detachable anode compartment, detachable cathode compartment, and a separator. 11 is the anode compartment in which the bottom has a metal screen. 16 is the top view of anode compartment with metal screen at the bottom, of which the anode compartment is a rectangular shape. 16-1 is the top view of anode compartment with metal screen at the bottom, of which the anode compartment is a circle shape. 12 is the cathode compartment in which the bottom has openings that allow air to diffuse into. 17 is the top view of the cathode compartment with openings at the bottom, of which the cathode compartment is a rectangular shape. 17-1 is the top view of the cathode compartment with openings at the bottom, of which the cathode compartment is a circle shape. 13 is the separator. 14 is the anode which is metal gel with electrolyte, for example, zinc gel with electrolyte usually of potassium hydroxide. 15 is the cathode material, usually comprised of current carrier with cathode catalyst that converts oxygen into hydroxyl anions.

When the battery system is in the storage mode, the anode and cathode are separated. In this status, the anode, usually zinc gel with electrolyte potassium hydroxide, is held by metal screen to be contained inside the anode compartment and separated from separator and cathode. Therefore, the electrolyte will not penetrate the separator and saturate the cathode catalyst causing loss of cathode activity. This mode solves the main drawback from conventional zinc air battery that the electrolyte, for example, potassium hydroxide, slowly penetrates into cathode resulting loss of battery power.

When the battery is put in use to generate electric power, the anode compartment and cathode compartment are pressed into contact, with the metal screen in direct contact with the separator and cathode catalyst, as shown in 18. With the contact of anode and cathode, electrochemical reaction will take place as conventional zinc air battery.

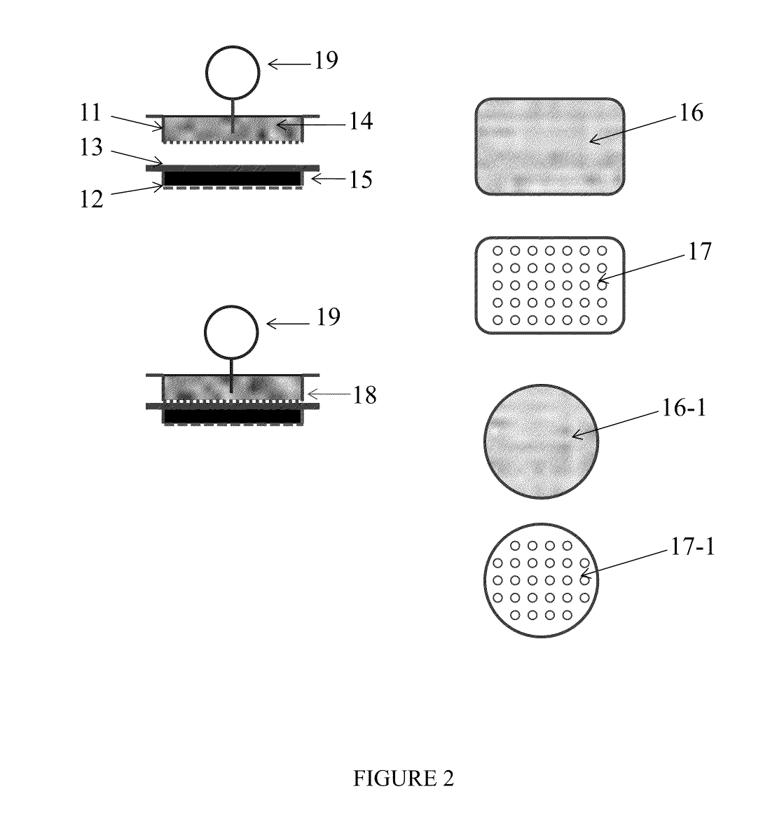

FIG. 2 is a schematic drawing of another embodiment of the battery system having features of this invention, wherein 19 is an injection device attached to battery system shown in FIG. 1, and this injection device is used for water and/or electrolyte addition to the metal gel when needed. When the metal gel loses moisture, a desirable amount of water and/or electrolyte is added through the injection port to the anode compartment.

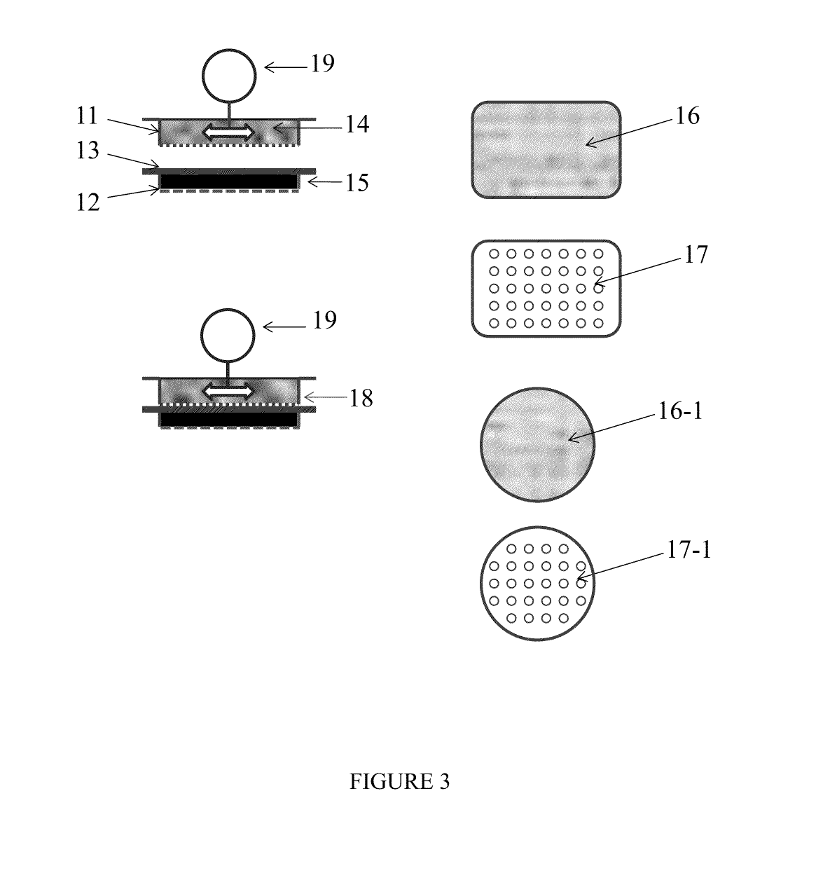

FIG. 3 is a schematic drawing of another embodiment of the battery system having features of this invention, wherein 20 is s stirring device attached to battery system shown in FIG. 1, and this stirring device can induce movement of metal gel when needed. When the battery power shows output power decrease, a stirring is initiated to a movement of the metal gel.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The following examples demonstrate the improved features of the battery system disclosed in this invention. A zinc air battery in which the anode compartment with metal screen to hold zinc gel together with electrolyte can be stored a long time without losing battery power due to the penetration of electrolyte into cathode compartment that would saturate the cathode catalyst. The examples are given solely for the illustration purposes and are not to be construed as a limitation of the present invention.

### EXAMPLE 1

A regular zinc air battery was tested as a base case, in which zinc gel was directly put on the separator on top of cathode material. In this zinc air battery used, the cathode with a cathode catalyst had an area of about 5 cm². The cathode catalyst was MnO₂ based catalyst supported on porous carbon. The anode was zinc gel with 35 wt. % potassium hydroxide as electrolyte.

The open circuit voltage was measured to be about 1.57 V. When the anode and cathode were electrically connected to an external load of 5 ohm, the electric current was about 220 mA during battery discharge. The operating voltage of the zinc air battery was about 1.2 V. The electric current was stable for over 1 hour of operation time.

Then the zinc air battery was disconnected from the external load, and was sat as is for over 48 hours. Afterwards, this zinc air battery was connected to the same external load of 5 ohm again. The electric current was dropped to about 170 mA during the battery discharge. The operating voltage of the zinc air battery was about 1.0 V. It was observed that the cathode catalyst was wet due to the penetration of potassium hydroxide electrolyte through the separator into cathode.

### EXAMPLE 2

A zinc air battery with the feature of this invention was tested. The anode compartment had a metal screen on the bottom of the anode compartment. The anode zinc gel with 35 wt. % potassium hydroxide as electrolyte was inside the anode compartment and was placed on top of a metal screen. As in Example 1, the cathode of the zinc air battery had an area of about 5 cm². The cathode catalyst was MoO₂ based catalyst supported on porous carbon.

The open circuit voltage was also measured to be about 1.57 V. Before testing, the anode compartment was pressed onto the separator on top of the cathode so that the anode and cathode were connected. When the anode and cathode were electrically connected to an external load of 5 ohm, the electric current was also about 220 mA during battery discharge. The operating voltage of the zinc air battery was also about 1.2 V. The electric current was stable for over 1 hour of operation time. This result showed that adding a metal screen between the anode and cathode does not change the performance of the battery.

Then the zinc air battery was disconnected from the load, and the anode compartment was also separated from the cathode. The battery was sat in detached mode for over 48 hours. Afterwards, the anode compartment was pressed again onto the separator on top of cathode so that the anode and cathode was connected. This zinc air battery was again connected to the same external load of 5 ohm. The electric current was still about 220 mA during the battery discharge. The operating voltage of the zinc air battery was about 1.2 V. It was observed that the cathode catalyst was dry before the testing. This result showed that by separating the anode with cathode during storage, there was no electrolyte penetration; therefore the cathode catalyst maintained the original activity without cathode catalyst deactivation due to saturation from electrolyte. Based on this invention, the storage time of the zinc air battery is significantly extended without loss of battery power.

Having thus described the invention, it should be apparent that numerous modifications and adaptations may be resorted to without departing from the scope and fair meaning of the instant invention as set forth hereinabove and as described herein by the claims.

What is claimed is:

1. A metal-air battery system with detachable anode compartment and cathode compartment for producing electric current, said metal-air battery system comprising of a detachable anode compartment, a detachable cathode compartment, an electrolyte, a separator, wherein said anode compartment and said cathode compartment are pressed into contact when the battery system is put in use to generate electric power; and said anode compartment and said cathode compartment are separated when the battery system is not in use to generate electric power;
said anode compartment comprising at least one type of metal gel together with said electrolyte, and said anode compartment has a metal screen at the bottom of the anode compartment to hold metal gel together with said electrolyte within the anode compartment;
said anode compartment comprising an injection device for injection of water mist into anode compartment to maintain a designed moisture level of the anode compartment;
said cathode compartment comprising oxygen, and/or air, an electrode catalyst, and current carriers;
said separator being attached to said cathode compartment, separates the anode with the cathode when said anode compartment and said cathode compartment are pressed into contact;
said battery system can be electrically connected in series and/or in parallel to provide desired electric power.

2. The metal-air battery system of claim 1 is a zinc-air battery system comprising of an anode compartment, a cathode compartment, an electrolyte, a separator, wherein said anode comprises zinc, an alloy of zinc, a mixture of zinc with other types of metal, or a combination thereof together with the electrolyte; said cathode comprises air and/or oxygen, a gas diffusion electrode catalyst, and current carriers, said separator being attached to said cathode, separates the anode with the cathode when said anode compartment and said cathode compartment are pressed into contact.

3. The metal-air battery system of claim 1, wherein the electrolyte comprises of hydroxide ions.

4. The metal-air battery system of claim 1, wherein the metal screen has mesh above 20, preferred between 40-100 mesh.

5. The metal-air battery system of claim 1, wherein the metal of the metal screen can be metal from Group IB, Group IIB, Group VIII, Group IIA, Group IIIA of periodic table, and/or alloys from above metals.

6. The metal-air battery system of claim 1, wherein the metal screen can be located at any side that is in contact with said cathode compartment.

7. The metal-air battery system of claim 1, wherein the injection device can also induce stirring movement of metal gel inside the anode compartment.

8. The metal-air battery system of claim 1 is included in another case that houses the battery system.

9. A method of recharging a metal-air battery system for continuous producing electric current by replacing the existing used anode compartment with an external anode compartment with fresh metal gel together with electrolyte;
said metal-air battery system comprising of a detachable anode compartment, a detachable cathode compartment, an electrolyte, a separator, wherein said anode compartment and said cathode compartment are pressed into contact when the battery system is put in use to generate electric power; and said anode compartment and said cathode compartment are separated when the battery system is not in use to generate electric power;
said anode compartment comprising at least one type of metal gel together with said electrolyte, and said anode compartment has a metal screen at the bottom of the anode compartment to hold metal gel together with said electrolyte within the anode compartment;
said anode compartment comprising an injection device for injection of water mist into anode compartment to maintain a designed moisture level of the anode compartment;
said cathode compartment comprising oxygen, and/or air, an electrode catalyst, and current carriers;
said separator being attached to said cathode compartment, separates the anode with the cathode when said anode compartment and said cathode compartment are pressed into contact;
said battery system can be electrically connected in series and/or in parallel to provide desired electric power.

10. The metal-air battery system of claim 9 is included in another case that houses the battery system.
